(19) United States
(12) Patent Application Publication
(10) Pub. No.: US 2025/0334530 A1
(43) Pub. Date: Oct. 30, 2025

(54) X-RAY REFLECTION ANALYSIS SYSTEM APPLYING MULTIPLE X-RAY BEAMS

(71) Applicant: NanoSeex Inc., Hsinchu County (TW)

(72) Inventors: KUO-FENG LIN, Hsinchu County (TW); TSUNG-HSIEN HAN, Hsinchu County (TW); CHUN-TING LIU, Hsinchu County (TW); PO-CHING HE, Hsinchu County (TW); PO-TSANG WU, Hsinchu County (TW)

(21) Appl. No.: 19/009,294

(22) Filed: Jan. 3, 2025

(30) Foreign Application Priority Data
Apr. 26, 2024 (TW) 113115628

(51) Int. Cl. G01N 23/207

(52) U.S. Cl. CPC G01N 23/207; G01N 2223/052; G01N 2223/054; G01N 2223/0566; G01N 2223/076; G01N 2223/1016

(57) ABSTRACT

An X-ray reflection analysis system applying multiple X-ray beams is provided. The X-ray reflection analysis system includes at least one X-ray source device, a diffraction component, at least one sensor, and a processing device. At least one X-ray source device is configured to generate a primary X-ray beam. The diffraction component is configured to split the primary X-ray beam into a plurality of sub X-ray beams in a matrix form. The at least one sensor is configured to receive a plurality of sensing signals respectively generated after a to-be-measured object is irradiated by the sub X-ray beams. The processing device is configured to control the X-ray source device to generate the primary X-ray beam and to analyze the plurality of sensing signals to generate a plurality of analysis results.

### CROSS-REFERENCE TO RELATED PATENT APPLICATION

This application claims the benefit of priority to Taiwan Patent Application No. 113115628, filed on Apr. 26, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system, and more particularly to an X-ray reflection analysis system applying multiple X-ray beams.

### BACKGROUND OF THE DISCLOSURE

In contemporary X-ray measurement systems, the analysis of small regions on a to-be-measured sample typically yields weak signal intensities, necessitating extended integration times to obtain data with sufficient resolution for meaningful interpretation. When multiple micro-area measurements are required at different positions on the sample, the cumulative measurement time can become significantly prolonged.

Furthermore, multi-point measurements necessitate repositioning the sample or rotating the light source to align with the desired micro-area measurement locations using mechanical mechanisms. However, such mechanical actuation is inherently time-intensive and introduces uncertainties into optical measurements, thereby affecting measurement accuracy; these limitations render existing X-ray measurement systems significantly time-consuming, while also impacting measurement efficiency and accuracy.

### SUMMARY OF THE DISCLOSURE

In response to the above-referenced technical inadequacies, the present disclosure provides an X-ray reflection analysis system applying multiple X-ray beams, which enhances the speed of multi-point measurements.

In order to solve the above-mentioned problems, one of the technical aspects adopted by the present disclosure is to provide an X-ray reflection analysis system, which includes at least one X-ray source device, a diffraction component, at least one sensor, and a processing device. At least one X-ray source device is configured to generate a primary X-ray beam. The diffraction component is configured to split the primary X-ray beam into a plurality of sub X-ray beams in a matrix form. The at least one sensor is configured to receive a plurality of sensing signals respectively generated after a to-be-measured object is irradiated by the sub X-ray beams. The processing device is configured to control the X-ray source device to generate the primary X-ray beam and to analyze the plurality of sensing signals to generate a plurality of analysis results.

Therefore, the X-ray reflection analysis system applying multiple X-ray beams provided by the present disclosure achieves simultaneous measurement of multiple micro-areas by utilizing a specially designed diffraction component with unique microstructures, combined with sensors arranged in a corresponding two-dimensional configuration, thereby significantly reducing the overall measurement time.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of the X-ray reflection analysis system applying multiple X-ray beams according to a first embodiment of the present disclosure;

FIG. 2 is a schematic diagram illustrating an operation of a diffraction component according to the first embodiment of the present disclosure;

FIG. 3 is a top view of the diffraction component according to the first embodiment of the present disclosure;

FIG. 4 is a graph showing a relationship between periodic dimensions and scattering angles according to the first embodiment of the present disclosure;

FIGS. 5 and 6 are respectively a top view and a perspective view of a second-order diffraction component according to the first embodiment of the present disclosure;

FIGS. 7 and 8 are respectively a top view and a perspective view of a fourth-order diffraction component according to the first embodiment of the present disclosure;

FIGS. 9 and 10 are respectively top views of an eighth-order diffraction component and a sixteenth-order diffraction component according to the first embodiment of the present disclosure;

FIG. 11 is a graph showing uniformity and dispersion efficiency of the second, fourth, eighth, and sixteenth-order diffraction components according to the first embodiment of the present disclosure;

FIG. 12 is a schematic diagram of the X-ray reflection analysis system applying multiple X-ray beams according to a second embodiment of the present disclosure; and

FIG. 13 is a top-view schematic diagram of the X-ray reflection analysis system applying multiple X-ray beams according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

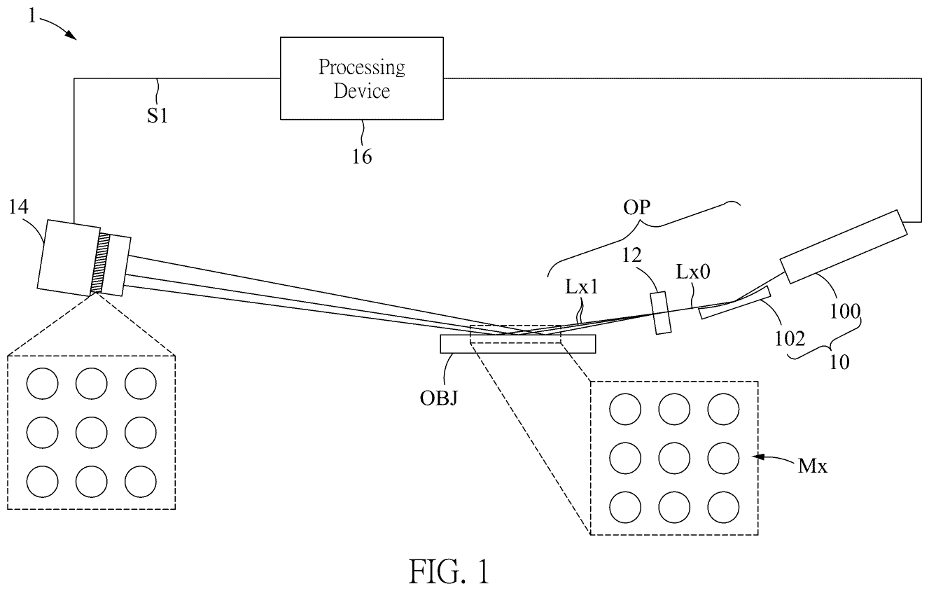

FIG. 1 is a schematic diagram of the X-ray reflection analysis system applying multiple X-ray beams according to a first embodiment of the present disclosure. Referring to FIG. 1, the first embodiment of the present disclosure provides an X-ray reflection analysis system 1, which includes an X-ray source device 10, a diffraction component 12, a sensor 14, and a processing device 16. As an example, the X-ray reflection analysis system 1 shown in FIG. 1 can be an X-ray critical dimension (XRCD) analysis system, where the sensor 14 corresponds to a reflective light sensor.

As shown in FIG. 1, the X-ray source device 10 can include at least one X-ray generator 100 and one or more optical elements 102. The X-ray generator 100, the optical elements 102, and the to-be-measured object OBJ are arranged along an optical path OP. The X-ray source device 10 is configured to generate a primary X-ray beam Lx0 through the X-ray generator 100. In this embodiment, the primary X-ray beam Lx0 is primarily used for X-ray analysis techniques. The primary X-ray beam Lx0 can, for example, be a beam with a wavelength range of 0.01 nanometers to 10 nanometers and can include hard X-ray beams, soft X-ray beams, or gamma-ray beams. The X-ray generator 100 can include an X-ray tube with an internal electron beam emitter and a target material. The target material is bombarded by the electron beam to produce X-rays. Additionally, by selecting different target materials, such as copper (Cu), aluminum (Al), iron (Fe), molybdenum (Mo), indium (In), and their related alloys, X-ray beams with different energies or wavelengths (or frequencies) can be generated.

To address the multi-point measurement challenge, this embodiment adopts a diffraction component 12 with a specific design. The diffraction component 12 is configured to split the primary X-ray beam Lx0 into a plurality of sub X-ray beams Lx1. These sub X-ray beams Lx1 can have a matrix form Mx. More specifically, when the sub X-ray beams Lx1 irradiate a surface of the to-be-measured object OBJ, they form multiple light spots arranged in the matrix form Mx, as shown in FIG. 1. It should be noted that, to meet the requirements for micro-area measurements, each light spot can be generated using a reflective mirror system composed of multiple optical elements 102, such as Kirkpatrick-Baez (KB) mirror sets. For example, by using two physically separated elliptical mirrors, the primary X-ray beam Lx0 can be focused into nanoscale light spots, which are projected onto the surface of the to-be-measured object OBJ. The reflected signals from the surface are then received by the sensor 14. The size of the light spots projected onto the surface of the to-be-measured object OBJ can be determined by controlling microstructures on the diffraction component 12, thereby achieving micro-area measurement results. Preferably, in this embodiment of the present disclosure, an area of each light spot formed by the sub X-ray beams Lx1 on the surface of the to-be-measured object OBJ is less than 2500 μm². If the light spots are circular, their diameter does not exceed 50 μm.

In the embodiment shown in FIG. 1, the diffraction component 12 is a designed optical element that can be positioned between the X-ray source device 10 and the to-be-measured object OBJ. In other embodiments, the diffraction component 12 can be positioned between any two of the X-ray generator 100, the optical elements 102, and the to-be-measured object OBJ, and located along an optical path OP.

The sensor 14 is configured to acquire a plurality of sensing signals S1 respectively generated after the to-be-measured object OBJ is irradiated by the plurality of sub X-ray beams Lx1. When the sub X-ray beams Lx1 simultaneously irradiate the to-be-measured object OBJ, reflection spectra at multiple points can be measured simultaneously, thereby reducing the overall sample measurement time. The sensor 14 can be, for example, a charge-coupled device (CCD) or a complementary metal-oxide-semiconductor (CMOS) image sensor with a two-dimensional array format (as shown in FIG. 1). Alternatively, it can use multiple sensor units, such as silicon drift detectors (SDD), to simultaneously receive the matrix form of multiple reflection signals and generate the corresponding plurality of sensing signals S1.

The processing device 16 can be, for example, a computer system that includes a processor and memory, and can be configured to execute stored instruction sets or codes to control the X-ray source device 10 to generate the primary X-ray beam Lx0 and analyze the sensing signals S1 to produce the analysis results.

In this embodiment, the processing device 16 can perform X-ray critical dimension (XRCD) analysis on the sensing signals generated by the sensor 14 (i.e., the reflective light sensor). For example, when the sub X-ray beams Lx1 are incident on the surface of the to-be-measured object OBJ, the XRCD analysis can be utilized to determine structural parameters of the to-be-measured object OBJ. As an illustration, when the to-be-measured object OBJ contains micro-components such as a gate-all-around field-effect transistor (GAA-FET), the XRCD analysis can be utilized to determine the critical dimensions and directionality of the GAA-FET based on the reflection spectra collected by the sensor. Furthermore, when the to-be-measured object OBJ includes multilayer structures, XRCD analysis can be utilized to determine the density, thickness, roughness, and other parameters of each layer based on the reflection spectra collected by the sensor.

In the embodiments of the present disclosure, the processing device 16 can perform a multi-model fitting processing on the plurality of sensing signals S1 based on a target structure model, thereby producing multiple structural parameters corresponding to the target structure model as the analysis results. In the multi-model fitting process, the measured reflection signals (i.e., the sensing signals S1) can be analyzed through modeling and fitting.

For instance, the processing device 16 can execute multiple electromagnetic wave calculation engines with different physical mechanisms to fit the measurement results. The measurement results can include, for example, reflection spectra obtained from the to-be-measured object OBJ under multiple incident angles. The fitting results can include structural parameters of the to-be-measured object OBJ, such as the critical dimensions of the GAA-FET. The electromagnetic wave calculation engines can include, for example, one or more of the following algorithms: finite-difference time-domain (FDTD), distorted wave born approximation (DWBA), rigorous coupled wave analysis (RCWA), discrete dipole approximation (DDA), and boundary element method (BEM). When the electromagnetic wave calculation engines generate the fitting results, corresponding difference functions and variances can be obtained. By statistically analyzing all the data, an initial fitting range can be established. Within this fitting range, random sampling and permutation can be employed to generate different structural parameters to be validated. Through iterative validation and feedback, the structural parameters can be optimized. The optimized structural parameters that satisfy an optimal condition can then be used as the final fitting results.

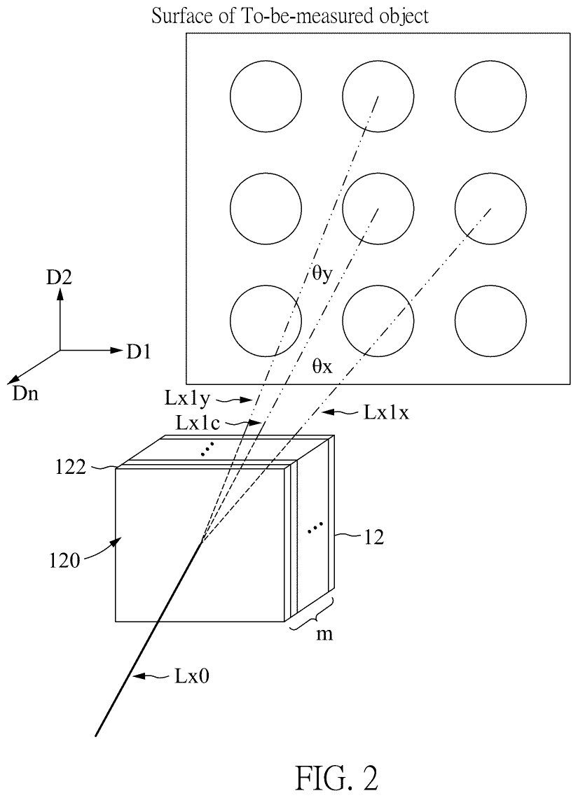

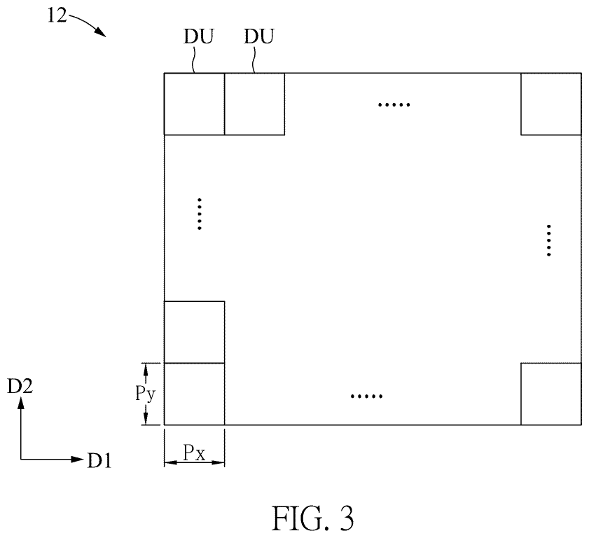

Referring to FIGS. 2 and 3, FIG. 2 is a schematic diagram illustrating an operation of a diffraction component according to the first embodiment of the present disclosure, and FIG. 3 is a top view of the diffraction component according to the first embodiment of the present disclosure. As shown in FIGS. 2 and 3, the diffraction component 12 includes an incident surface 120 and a plurality of diffraction units DU periodically arranged along the incident surface 120. Each diffraction unit DU has a first length Px in a first direction D1 and a second length Py in a second direction D2. The incident surface 120 has a normal direction Dn, and the first direction D1, the second direction D2, and the normal direction Dn are mutually perpendicular.

As illustrated in FIG. 2, the matrix form Mx includes a k*k matrix, where k is an odd number greater than or equal to 3. For example, the matrix form Mx can include 33, 55, or 7*7 matrices. The plurality of sub X-ray beams Lx1 includes a central beam Lx1c. The sub X-ray beam Lx1x nearest to the central beam Lx1c in the first direction D1 has a first scattering angle θx, and the sub X-ray beam Lx1y nearest to the central beam Lx1c in the second direction D2 has a second scattering angle θy.

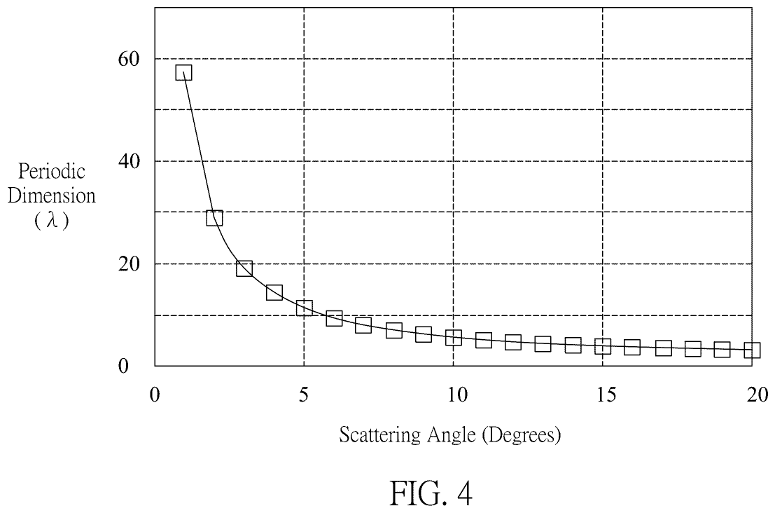

FIG. 4 is a graph showing a relationship between periodic dimensions and scattering angles according to the first embodiment of the present disclosure. Referring to FIG. 4, in the diffraction component 12, pitch sizes in the first direction D1 and the second direction D2, which correspond to the first length Px and the second length Py of the single diffraction unit DU, are determined by the required first scattering angle θx and second scattering angle Oy, respectively. Additionally, the number of diffraction units DU in the first direction D1 and the second direction D2 depends on the required number of light spots, which corresponds to the size of the matrix.

On the other hand, in this embodiment, the first length Px and the second length Py can be determined using the following equations (1) and (2):

$${P}_{x} = λ / sin {θ}_{x} ; \qquad Equation ( 1 )$$

$${P}_{y} = λ / sin {θ}_{y} ; \qquad Equation ( 2 )$$

Where 2 is the predetermined wavelength of the primary X-ray beam Lx0, θₓ is the first scattering angle, and θ_{y} is the second scattering angle. From equations (1) and (2), it can be concluded that the first length Px and the second length Py are proportional to the predetermined wavelength λ of the primary X-ray beam Lx0. The first length Px is inversely proportional to a sine function of the first scattering angle θx, and the second length Py is inversely proportional to a sine function of the second scattering angle θy.

On the other hand, the diffraction component 12 is an m-order diffraction component consisting of m material layers 122 stacked together. The overall height of the diffraction component 12 can be determined based on the refractive index of the materials, as described in equation (3):

$$Htotal = λ / ( n - 1 ) ; \qquad Equation ( 3 )$$

where Htotal represents the total height of the diffraction component 12, n is the refractive index of the material layers 122, and λ is the predetermined wavelength of the primary X-ray beam Lx0. Furthermore, a height of each material layer 122 can be expressed using the following equation (4):

$$Hm = λ / ( m * ( n - 1 ) ) ; \qquad Equation ( 4 )$$

where Hm represents the height of each material layer 122, m is an integer greater than or equal to 2, n is the refractive index of each material layer 122, and λ is the predetermined wavelength of the primary X-ray beam Lx0. Each material layer 122 can be made of a high-density metal material, such as gold (Au), platinum (Pt), or silver (Ag), and exhibits a reflectivity greater than 95% at the predetermined wavelength.

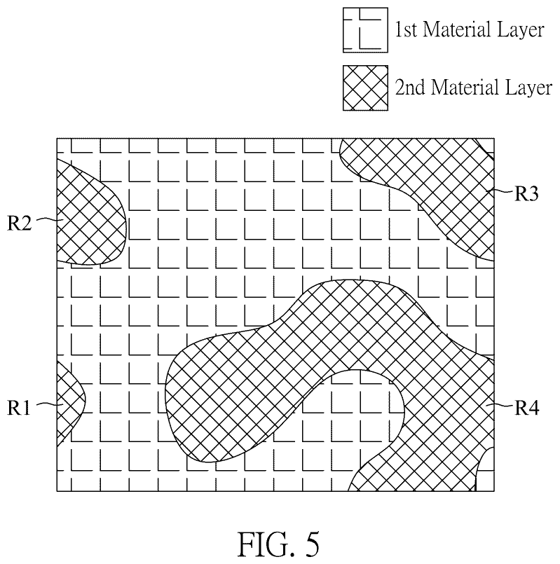

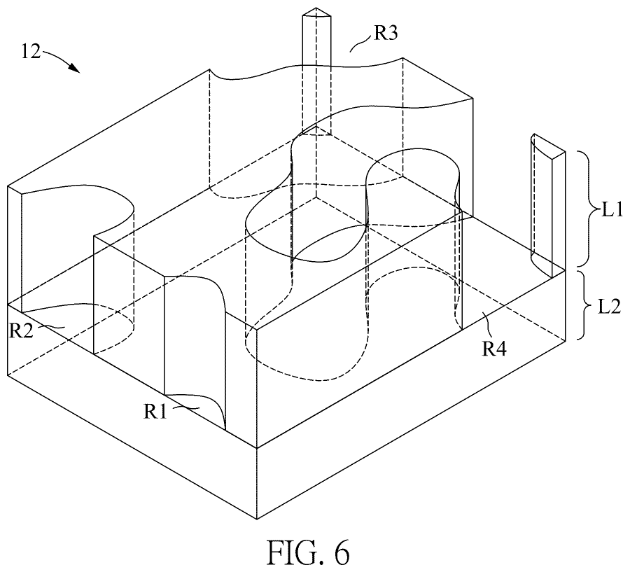

FIGS. 5 and 6 are respectively a top view and a perspective view of a second-order diffraction component according to the first embodiment of the present disclosure. Referring further to FIGS. 5 and 6, when k is 5 (i.e., a 5*5 matrix of light spots can be generated) and m is 2, each diffraction unit DU exhibits a rectangle from a top-view perspective and includes a first material layer L1 and a second material layer L2. As shown in FIG. 6, the first material layer L1 is positioned above the second material layer L2. The first material layer L1 features four concave portions R1, R2, R3, and R4 that expose the top surface of the second material layer L2. These concave portions have varying cross-sectional areas and are located at the four corners of the rectangle. The concave portions R1, R2, R3, and R4 sequentially increase in cross-sectional area. The concave portions R1 and R2 exhibit a hill-like shape, the concave portion R3 has a heart-like shape, and the concave portion R4 exhibits a C-like shape. The concave portions R1 and R3 are located at two opposite corners, while concave portions R2 and R4 are located at the other two opposite corners.

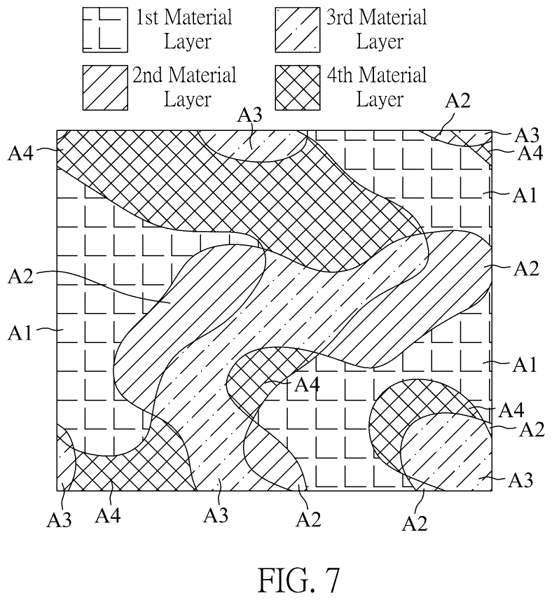

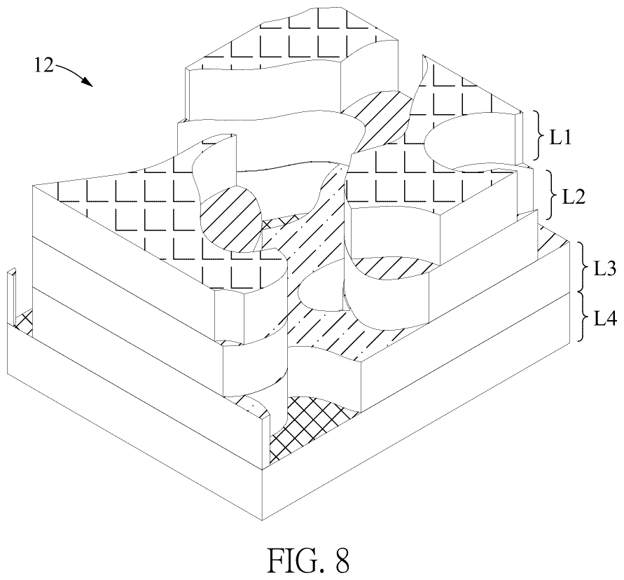

FIGS. 7 and 8 are respectively a top view and a perspective view of a fourth-order diffraction component according to the first embodiment of the present disclosure. When k is 5 (i.e., a 5*5 matrix of light spots can be generated) and m is 4, each diffraction unit DU exhibits a rectangle from a top-view perspective and includes the first material layer L1, the second material layer L2, the third material layer L3, and the fourth material layer L4 that are sequentially stacked. Furthermore, within each diffraction unit DU, there are three first regions A1, six second regions A2, five third regions A3, and five fourth regions A4, arranged from high to low in position. The first regions A1 correspond to a top cross-section of the first material layer L1, the second regions A2 correspond to an uncovered top cross-section of the second material layer L2, the third regions A3 correspond to an uncovered top cross-section of the third material layer L3, and the fourth regions A4 corresponds to an uncovered top cross-section of the fourth material layer L4.

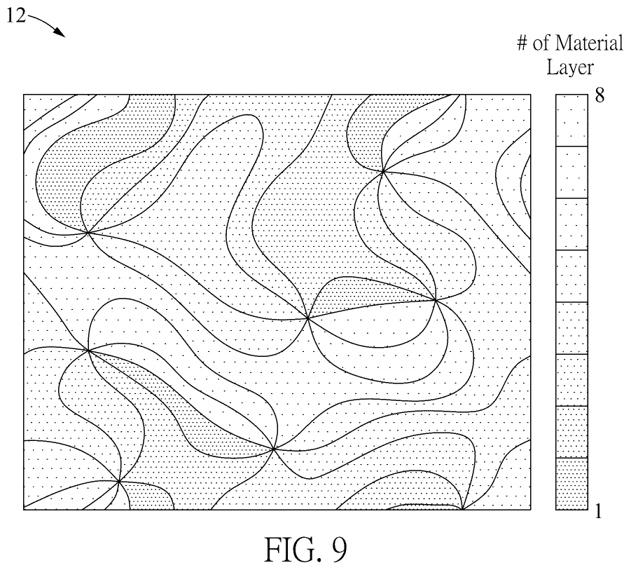

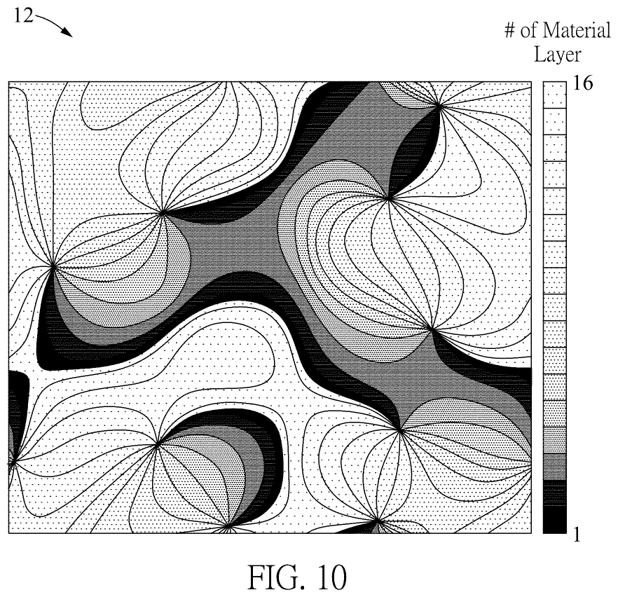

FIGS. 9 and 10 are respectively top views of an eighth-order diffraction component and a sixteenth-order diffraction component according to the first embodiment of the present disclosure. It should be noted that the eighth-order diffraction component (m=8) shown in FIG. 9 and the sixteenth-order diffraction component (m=16) shown in FIG. 10 can be used to generate a 5*5 matrix of light spots (k=5). For simplicity, the three-dimensional morphology of each material layer in the eighth-order and sixteenth-order diffraction components is omitted. As shown in FIG. 9, the eighth-order diffraction component has eight material layers, represented by eight different shades to indicate the uncovered regions of each layer. Similarly, FIG. 10 shows that the sixteenth-order diffraction component has sixteen material layers, represented by sixteen different shades to indicate the uncovered regions of each layer.

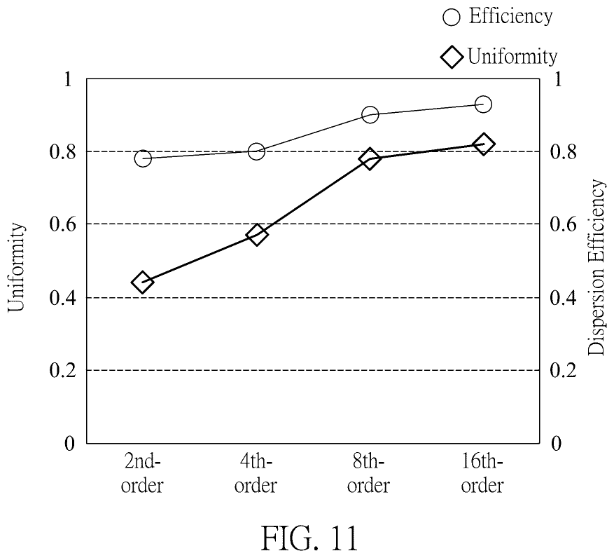

Referring to FIG. 11, FIG. 11 is a graph showing uniformity and dispersion efficiency of the second, fourth, eighth, and sixteenth-order diffraction components according to the first embodiment of the present disclosure. As illustrated in FIG. 11, as the number of orders of the diffraction component 12 increases, both uniformity and dispersion efficiency also improve. Here, uniformity refers to energy differences among the sub X-ray beams Lx1, and dispersion efficiency refers to a ratio of a total energy of the sub X-ray beams Lx1 reaching the to-be-measured object OBJ relative to an incident energy of the primary X-ray beam Lx0 when diffracted by the diffraction component 12. For example, as shown in FIG. 11, the sixteenth-order diffraction component can effectively control the total energy reaching the to-be-measured object OBJ at over 80% of the incident energy, thereby reducing energy loss during the diffraction process.

Thus, by utilizing the diffraction component 12 with specially designed microstructures, combined with the sensor 14 configured in a corresponding two-dimensional array, simultaneous measurement of multiple micro-areas can be achieved, significantly reducing the overall measurement time. Moreover, during multi-point measurements, there is no need to move the to-be-measured object OBJ or rotate the X-ray source device 10 to the desired micro-area measurement positions using the mechanical mechanism, which eliminates the time required for mechanical actuation and avoids the uncertainties that mechanical movements introduce to optical measurements, thereby improving measurement accuracy.

### Second Embodiment

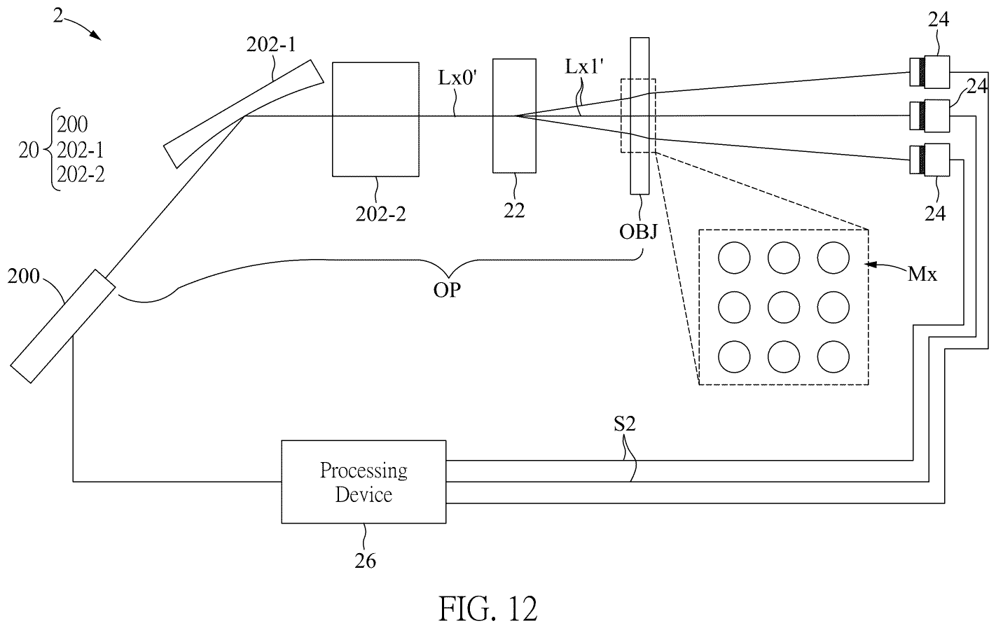

FIG. 12 is a schematic diagram of an X-ray reflection analysis system 2 applying multiple X-ray beams according to a second embodiment of the present disclosure. As shown in FIG. 12, the second embodiment of the present disclosure provides the X-ray reflection analysis system 2, which includes an X-ray source device 20, a diffraction component 22, sensors 24, and a processing device 26. For example, the X-ray reflection analysis system 2 shown in FIG. 12 serves as an X-ray diffraction (XRD) analysis system, where the sensors 24 are diffractive light sensors correspondingly.

The X-ray source device 20 can include an X-ray generator 200 and optical elements 202-1 and 202-2. The optical element 202-1 can be a KB mirror set for focusing, while the optical element 202-2 can be a collimating lens. The X-ray generator 200, optical elements 202-1 and 202-2, and the to-be-measured object OBJ are arranged along an optical path OP. The X-ray source device 20 is configured to generate a primary X-ray beam Lx0′ through the X-ray generator 200.

Similarly, to address the multi-point measurement challenge, this embodiment employs the diffraction component 22 with a specific design. The diffraction component 22 is used to split the primary X-ray beam Lx0′ into a plurality of sub X-ray beams Lx1′. When these sub X-ray beams Lx1′ irradiate the surface of the to-be-measured object OBJ, they form multiple light spots, as shown in FIG. 12, arranged in a matrix form Mx. The primary X-ray beam Lx0′ can be focused to nanoscale light spots via the optical elements 202-1 and 202-2, projected onto the surface of the to-be-measured object OBJ, and transmitted signals are then received by the sensors 24. The size of the light spots projected onto the surface of the to-be-measured object OBJ can be determined by controlling microstructures on the diffraction component 22, thereby achieving micro-area measurement results.

In the embodiment shown in FIG. 12, the diffraction component 22 adopts microstructures similar to those of the diffraction component 12 in the first embodiment, and it can be, for example, a second-order, fourth-order, eighth-order, or sixteenth-order diffraction component. The diffraction component 22 can be positioned between the X-ray source device 20 and the to-be-measured object OBJ. In other embodiments, the diffraction component 22 can be positioned between any two of the X-ray generator 200, the optical elements 202-1 and 202-2, and the to-be-measured object OBJ, and located along the optical path OP.

In this embodiment, the number of the sensors 24 are plural, with at least a portion of the sensors 24 configured in a manner corresponding to the matrix form Mx. These sensors 24 are used to acquire the sensing signals S2 generated by diffraction when the to-be-measured object OBJ is irradiated by the plurality of sub X-ray beams Lx1′.

More specifically, in the X-ray diffraction (XRD) analysis system, when the to-be-measured object OBJ is irradiated by the plurality of sub X-ray beams Lx1′, diffraction signals (i.e., the sensing signals S2) generated by sub X-ray beams Lx1′ incident at specific angles (e.g., Bragg angles) can be used for X-ray diffraction analysis. For instance, XRD analysis can determine the crystal structure, lattice constants, and strain of the to-be-measured object OBJ. The details of the XRD analysis are similar to the multi-model fitting process in the first embodiment. The processing device 26 can be configured to execute multiple electromagnetic wave calculation engines with different physical mechanisms to fit the measurement results and generate multiple structural parameters corresponding to the target structural model as analysis results.

Thus, by utilizing the diffraction component 22 with specially designed microstructures and the sensors 24 configured in a matrix, simultaneous measurement of sensing signals over multiple micro-areas can be achieved, significantly reducing overall measurement time. Moreover, during multi-point measurements, there is no need to move the to-be-measured object OBJ or rotate the X-ray source device 20 to the desired micro-area measurement positions using the mechanical mechanism, which eliminates the time required for mechanical actuation and avoids the uncertainties that mechanical movements introduce to optical measurements, thereby improving measurement accuracy.

### Third Embodiment

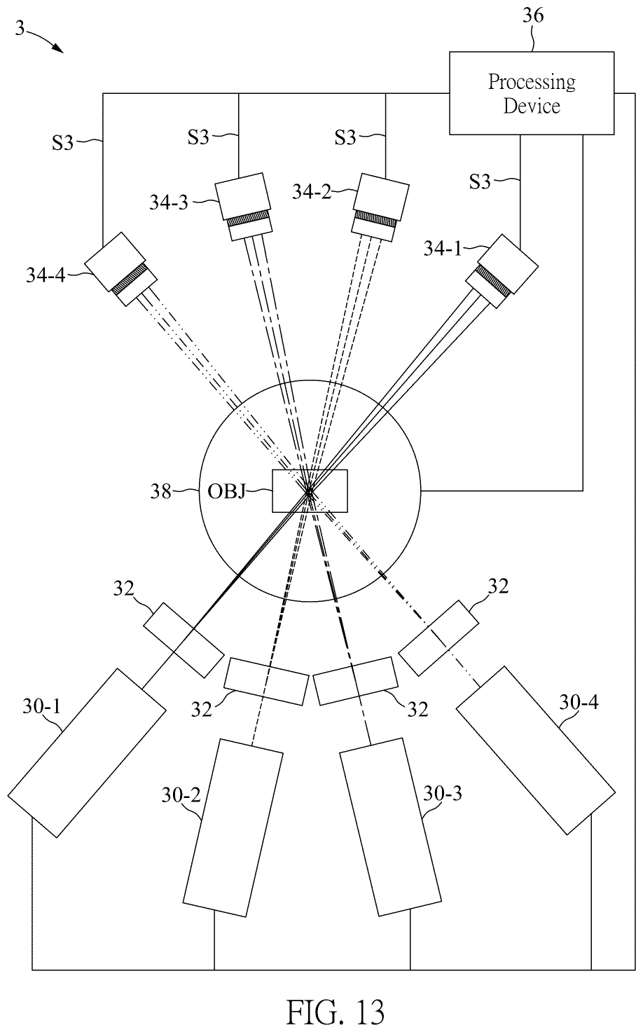

FIG. 13 is a top-view schematic diagram of the X-ray reflection analysis system applying multiple X-ray beams according to a third embodiment of the present disclosure. As shown in FIG. 13, the third embodiment of the present disclosure provides an X-ray reflection analysis system 3, which includes X-ray source devices 30-1, 30-2, 30-3, and 30-4, a plurality of diffraction components 32, sensors 34-1, 34-2, 34-3, and 34-4, a processing device 36 and a measurement platform 38 for holding the to-be-measured object OBJ. As an example, the X-ray reflection analysis system 3 shown in FIG. 13 serves as an integrated X-ray analysis system, which can include one or more of the following: an X-ray critical dimension (XRCD) analysis system, an X-ray diffraction (XRD) analysis system, a small-angle X-ray scattering (SAX) analysis system, and an X-ray fluorescence (XRF) analysis system. It should be noted that the processing device 36 can be configured to control a driving mechanism of the measurement platform 38 to rotate, allowing the to-be-measured object OBJ to receive sub X-ray beams incident at predetermined angles.

Additionally, each of the sensors 34-1, 34-2, 34-3, and 34-4 can be, for example, a reflective light sensor, a diffractive light sensor, a scattering light sensor, or a fluorescence sensor. The X-ray source devices 30-1, 30-2, 30-3, and 30-4 can each include an X-ray generator and one or more optical elements, and can be used to generate primary X-ray beams.

Similarly, to address the multi-point measurement challenge, this embodiment employs multiple diffraction components 32 with specific designs. These diffraction components 32 are used to split the primary X-ray beams generated by the X-ray source devices 30-1, 30-2, 30-3, and 30-4 into multiple sub X-ray beams, respectively. When these sub X-ray beams Lx1′ irradiate the surface of the to-be-measured object OBJ, a matrix form is exhibited.

In the embodiment shown in FIG. 12, the diffraction components 32 adopt microstructures similar to those of the diffraction component 12 in the first embodiment, and can be, for example, the aforementioned second-order, fourth-order, eighth-order, and sixteenth-order diffraction components. The diffraction components 32 can be positioned between the to-be-measured object OBJ and the X-ray source devices 30-1, 30-2, 30-3, or 30-4.

In this embodiment, the sensors 34-1, 34-2, 34-3, and 34-4 correspond to the X-ray source devices 30-1, 30-2, 30-3, and 30-4, respectively, and are used to acquire the plurality of sensing signals S3 generated by diffraction when the to-be-measured object OBJ is irradiated by the corresponding sub X-ray beams.

When the X-ray reflection analysis system 3 includes the XRCD analysis system and the XRD analysis system, configurations of the sensors 34-1, 34-2, 34-3, and 34-4, as well as the corresponding X-ray source devices 30-1, 30-2, 30-3, and 30-4, can adopt those described in the first and second embodiments. These configurations are not elaborated here for brevity.

When the X-ray reflection analysis system 3 includes an SAX analysis system, the small-angle incident sub X-ray beams with the matrix form can be used. These sub X-ray beams are scattered by the to-be-measured object OBJ, and one or more of the sensors 34-1, 34-2, 34-3, and 34-4 can be configured to receive the scattered signals. These signals are then analyzed by the processing device 36 through the SAX analysis to determine dimensions (such as critical dimensions of GAA structures), height, and width of periodic structures of the to-be-measured object OBJ.

When the X-ray reflection analysis system 3 includes the XRF analysis system, an array of multiple sub X-ray beams can be used to irradiate the to-be-measured object OBJ, exciting it and causing the emission of corresponding fluorescence. One or more of the sensors 34-1, 34-2, 34-3, and 34-4 can be configured to receive the fluorescence signals, which are analyzed by the processing device 36 through XRF analysis. Since the emitted fluorescence is related to the energy bands of the to-be-measured object OBJ, this analysis can reveal material properties or elemental composition of the to-be-measured object OBJ.

Thus, by utilizing the diffraction component 22 with specially designed microstructures and the sensors 24 configured in a matrix, simultaneous measurement of sensing signals over multiple micro-areas can be achieved, significantly reducing overall measurement time. Moreover, during multi-point measurements, there is no need to move the to-be-measured object OBJ or rotate the X-ray source devices to the desired micro-area measurement positions using the mechanical mechanism, which eliminates the time required for mechanical actuation and avoids the uncertainties that mechanical movements introduce to optical measurements, thereby improving measurement accuracy.

### Beneficial Effects of the Embodiments

In conclusion, the X-ray reflection analysis system applying multiple X-ray beams provided by the present disclosure achieves simultaneous measurement of multiple micro-areas by utilizing the diffraction component with unique microstructures, combined with sensors arranged in a matrix configuration, thereby significantly reducing the overall measurement time.

Moreover, during multi-point measurements, there is no need to move the to-be-measured object or rotate the X-ray source devices to the desired micro-area measurement positions using the mechanical mechanism, which eliminates the time required for mechanical actuation and avoids the uncertainties that mechanical movements introduce to optical measurements, thereby improving measurement accuracy.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An X-ray reflection analysis system applying multiple X-ray beams, comprising:
at least one X-ray source device configured to generate a primary X-ray beam;
a diffraction component configured to split the primary X-ray beam into a plurality of sub X-ray beams in a matrix form;
at least one sensor configured to receive a plurality of sensing signals respectively generated after a to-be-measured object is irradiated by the sub X-ray beams; and
a processing device configured to control the X-ray source device to generate the primary X-ray beam and to analyze the plurality of sensing signals to generate a plurality of analysis results.

2. The X-ray reflection analysis system according to claim 1, wherein the diffraction component has an incident surface and includes a plurality of diffraction components arranged along the incident surface, each of the plurality of diffraction unit has a first length in a first direction and a second length in a second direction.

3. The X-ray reflection analysis system according to claim 2, wherein the incident surface has a normal direction, and the first direction, the second direction, and the normal direction are mutually perpendicular.

4. The X-ray reflection analysis system according to claim 2, wherein the matrix form includes a k*k matrix, and k is an odd number greater than or equal to 3.

5. The X-ray reflection analysis system according to claim 4, wherein the plurality of sub X-ray beams include a central beam, and the sub X-ray beam closest to the central beam in the first direction has a first scattering angle, and the sub X-ray beam closest to the central beam in the second direction has a second scattering angle.

6. The X-ray reflection analysis system according to claim 5, wherein the first length and the second length are proportional to a predetermined wavelength of the primary X-ray beam, the first length is inversely proportional to a sine function of the first scattering angle, and the second length is inversely proportional to a sine function of the second scattering angle.

7. The X-ray reflection analysis system according to claim 6, wherein the diffraction component is an m-order diffraction component including m material layers stacked together, and a height of each of the m material layers is represented by following equation:
$$Hm = λ / m * ( n - 1 ) ,$$
where Hm is the height of each of the m material layers, m is an integer greater than or equal to 2, n is a refractive index of each of the m material layers, and λ is the predetermined wavelength.

8. The X-ray reflection analysis system according to claim 7, wherein, when n=5 and m=2, each of the plurality of diffraction units forms a rectangle in a top view and includes a first material layer and a second material layer, the first material layer is located above the second material layer and includes four concave portions with different cross-sectional areas respectively located at four corners of the rectangle.

9. The X-ray reflection analysis system according to claim 7, wherein, when n=5 and m=4, each of the plurality of diffraction units forms a rectangle in a top view and includes a first material layer, a second material layer, a third material layer, and a fourth material layer sequentially stacked, and each of the plurality of diffraction unit forms three first regions, six second regions, five third regions, and five fourth regions that are arranged from high to low.

10. The X-ray reflection analysis system according to claim 7, wherein each of the m material layers has a reflectivity greater than 95% at the predetermined wavelength.

11. The X-ray reflection analysis system according to claim 1, wherein a quantity of the least one sensor is plural, and at least a portion of the sensors are arranged in a manner corresponding to the matrix form.

12. The X-ray reflection analysis system according to claim 11, wherein each of the sensors includes at least one of:
a reflective light sensor configured to acquire the sensing signals generated by reflection after the to-be-measured object is irradiated by the plurality of sub X-ray beams;
a diffractive light sensor, configured to acquire the sensing signals generated by diffraction after the to-be-measured object is irradiated by the plurality of sub X-ray beams;
a scattering light sensor configured to acquire the sensing signals generated by scattering after the to-be-measured object is irradiated by the plurality of sub X-ray beams; and
a fluorescence sensor configured to acquire the sensing signals generated by excitation after the to-be-measured object is irradiated by the plurality of sub X-ray beams.

13. The X-ray reflection analysis system according to claim 12, wherein the processing device is configured to execute a multi-model fitting process on the sensing signals based on a target structure model to generate a plurality of structural parameters corresponding to the target structure model as the plurality of analysis results.

14. The X-ray reflection analysis system according to claim 13, wherein the processing device is configured to perform an X-ray critical dimension (XRCD) analysis on the sensing signals acquired by the reflective light sensor.

15. The X-ray reflection analysis system according to claim 13, wherein the processing device is configured to perform an X-ray diffraction (XRD) analysis on the sensing signals acquired by the diffractive light sensor.

16. The X-ray reflection analysis system according to claim 13, wherein the processing device is configured to perform a small-angle X-ray scattering (SAX) analysis on the sensing signals acquired by the scattering light sensor.

17. The X-ray reflection analysis system according to claim 13, wherein the processing device is configured to perform an X-ray fluorescence (XRF) analysis on the sensing signals generated by the fluorescence sensor.

18. The X-ray reflection analysis system according to claim 1, wherein each of the at least one X-ray source device includes an X-ray generator and a plurality of optical elements, the X-ray generator, the plurality of optical elements, and the to-be-measured object are arranged along an optical path, the diffraction component is further arranged on the optical path between any two of the X-ray generator, the plurality of optical elements, and the to-be-measured object.
